(19) United States
(12) Patent Application Publication
(10) Pub. No.: US 2026/0119435 A1
(43) Pub. Date: Apr. 30, 2026

(54) MULTIPLE TIERS NETWORK-ON-CHIP ARCHITECTURE

(71) Applicant: TAIWAN SEMICONDUCTOR MANUFACTURING COMPANY, LTD., Hsinchu (TW)

(72) Inventors: Ashwin Sanjay LELE, San Jose, CA (US); Win-San KHWA, Taipei City (TW); Brian CRAFTON, San Jose, CA (US); Bo ZHANG, San Jose, CA (US); Meng-Fan CHANG, Taichung City (TW)

(73) Assignee: TAIWAN SEMICONDUCTOR MANUFACTURING COMPANY, LTD., Hsinchu (TW)

(21) Appl. No.: 18/929,809

(22) Filed: Oct. 29, 2024

(51) Int. Cl. G06F 13/40; G06F 15/78

(52) U.S. Cl. CPC G06F 13/4027; G06F 15/7807

(57) ABSTRACT

A device is provided and includes multiple first processing units; multiple first connections each coupled between corresponding two units in the processing units; and a first intermediate node coupled to the first processing units through multiple second connections different from the first connections. Each of the first processing units is configured to transmit inter-unit communication to a corresponding unit in the first processing units through at least one of the first connections when the first intermediate node is bypassed.

### BACKGROUND

In GPU-like SoC designs, multiple cores share access to the main memory for reading and writing data. This setup can lead to performance issues when several data transfers occur simultaneously, causing memory congestion and resulting in core stalls. To alleviate the negative impact on throughput, expensive out-of-order processing techniques are often employed to manage and optimize the data flow.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a flowchart diagram of a method, in accordance with some embodiments of the present disclosure.

FIG. 2 is a schematic diagram of a device, in accordance with various embodiments of the present disclosure.

FIG. 3 is a schematic diagram of a device, in accordance with various embodiments of the present disclosure.

FIG. 4 is a schematic diagram of a device, in accordance with various embodiments of the present disclosure.

FIG. 5 is a schematic diagram of a device, in accordance with various embodiments of the present disclosure.

FIG. 6 is a schematic diagram part of a device corresponding to FIG. 2, in accordance with various embodiments of the present disclosure.

FIG. 7 is a schematic diagram of matrix multiplication, in accordance with various embodiments of the present disclosure.

FIG. 8 is a schematic diagram of timing of multicast operation, matrix multiplication operations, and core-to-core transfer corresponding to FIG. 7, in accordance with various embodiments of the present disclosure.

FIG. 9 is a schematic diagram of part of matrix multiplication corresponding to FIG. 7, in accordance with various embodiments of the present disclosure.

FIG. 10A is a schematic diagram of data flow in part of matrix multiplication corresponding to FIGS. 7 and 9, in accordance with various embodiments of the present disclosure.

FIG. 10B is a schematic diagram of data flow in accumulation in the matrix multiplication corresponding to FIGS. 7 and 9, in accordance with various embodiments of the present disclosure.

FIG. 11 is a schematic diagram part of the device adapted for the matrix multiplication FIG. 7, in accordance with various embodiments of the present disclosure.

FIG. 12 is a schematic diagram of part of matrix multiplication corresponding to FIG. 7, in accordance with various embodiments of the present disclosure.

FIG. 13A is a schematic diagram of data flow in part of matrix multiplication corresponding to FIGS. 7 and 12, in accordance with various embodiments of the present disclosure.

FIG. 13B is a schematic diagram of data flow in accumulation in the matrix multiplication corresponding to FIGS. 7 and 12, in accordance with various embodiments of the present disclosure.

FIG. 14 is a schematic diagram of data transfer corresponding to multiplications of matrices Q, K^{T}, and V in accordance with various embodiments of the present disclosure.

FIG. 15A is a schematic diagram of data flow before phase 1 of multiplications of matrices Q and K^{T}, in accordance with various embodiments of the present disclosure.

FIG. 15B is a schematic diagram of data flow in phase 1 of multiplications of matrices Q and K^{T}, in accordance with various embodiments of the present disclosure.

FIG. 15C is a schematic diagram of data flow before phase 2 of multiplications of matrices Q and K^{T}, in accordance with various embodiments of the present disclosure.

FIG. 15D is a schematic diagram of data flow in phase 2 of multiplications of matrices Q and K^{T}, in accordance with various embodiments of the present disclosure.

FIG. 15E is a schematic diagram of data flow in final stage of multiplications of matrices Q and K^{T}, in accordance with various embodiments of the present disclosure.

FIG. 16A is a schematic diagram of data flow before phase 1 of multiplications of matrices A and V, in accordance with various embodiments of the present disclosure.

FIG. 16B is a schematic diagram of data flow in phase 1 of multiplications of matrices A and V, in accordance with various embodiments of the present disclosure.

FIG. 16C is a schematic diagram of data flow before phase 2 of multiplications of matrices A and V, in accordance with various embodiments of the present disclosure.

FIG. 16D is a schematic diagram of data flow in phase 2 of multiplications of matrices A and V, in accordance with various embodiments of the present disclosure.

### DETAILED DESCRIPTION

The following disclosure provides many different embodiments, or examples, for implementing different features of the provided subject matter. Specific examples of components, materials, values, steps, arrangements or the like are described below to simplify the present disclosure. These are, of course, merely examples and are not intended to be limiting. Other components, materials, values, steps, arrangements or the like are contemplated. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

The terms applied throughout the following descriptions and claims generally have their ordinary meanings clearly established in the art or in the specific context where each term is used. Those of ordinary skill in the art will appreciate that a component or process may be referred to by different names. Numerous different embodiments detailed in this specification are illustrative only, and in no way limits the scope and spirit of the disclosure or of any exemplified term.

It is worth noting that the terms such as “first” and “second” used herein to describe various elements or processes aim to distinguish one element or process from another. However, the elements, processes and the sequences thereof should not be limited by these terms. For example, a first element could be termed as a second element, and a second element could be similarly termed as a first element without departing from the scope of the present disclosure.

In the following discussion and in the claims, the terms “comprising,” “including,” “containing,” “having,” “involving,” and the like are to be understood to be open-ended, that is, to be construed as including but not limited to. As used herein, instead of being mutually exclusive, the term “and/or” includes any of the associated listed items and all combinations of one or more of the associated listed items.

As used herein, “around”, “about”, “approximately” or “substantially” shall generally refer to any approximate value of a given value or range, in which it is varied depending on various arts in which it pertains, and the scope of which should be accorded with the broadest interpretation understood by the person skilled in the art to which it pertains, so as to encompass all such modifications and similar structures. In some embodiments, it shall generally mean within 20 percent, preferably within 10 percent, and more preferably within 5 percent of a given value or range. Numerical quantities given herein are approximate, meaning that the term “around”, “about”, “approximately” or “substantially” can be inferred if not expressly stated, or meaning other approximate values.

In some architectures, multiple cores access data through main memory, potentially causing stalls during core-to-core transfers. AI-SoCs with many cores use a mesh Network-on-Chip (NoC) architecture, where each core has its own local memory. This design scales well but requires complex routing and dense wiring. Without central memory, multi-casting data from one core to multiple cores needs advanced packet transfer algorithms. NoCs enhance scalability and performance by connecting cores, memory blocks, and peripherals within a chip using a network-like structure, similar to internet data routing, thus managing data traffic, reducing bottlenecks, and improving overall system efficiency.

In some embodiments, a two-tiered NoC architecture combining bus and ring structures offers multiple connectivity options between processor cores to reduce delays from queued transfers. Analysis of matrix multiplication within attention layers shows extensive core-to-core data exchanges that rely solely on main memory, suggesting an additional ring connection within the SoC to alleviate main memory load during such transfers. NoC configurations are provided, which can be employed individually or combined, supported by cost-effective multiplexer-based routers rather than complex routing algorithms. This application prevents stalling within SoCs without the need for additional hardware for stall operations by a memory controller. It also potentially doubles the speed of partitioned matrix multiplication evaluations by providing alternative data transfer routes and could halve energy consumption in main memory when it operates in deep-sleep mode while utilizing the ring for communication.

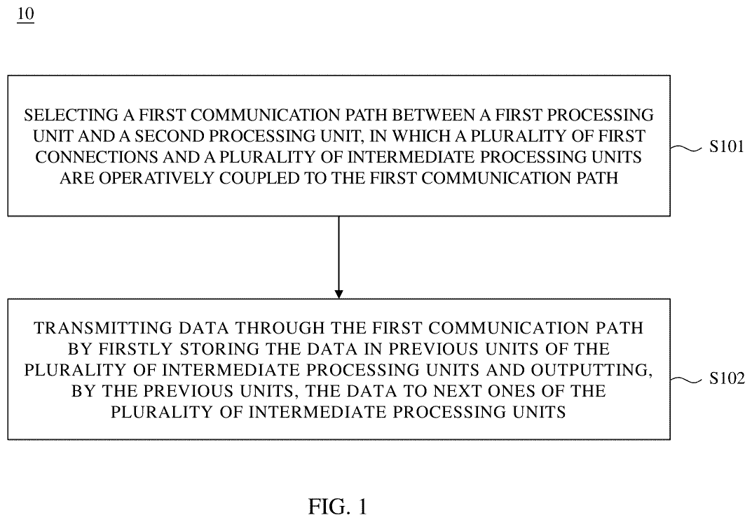

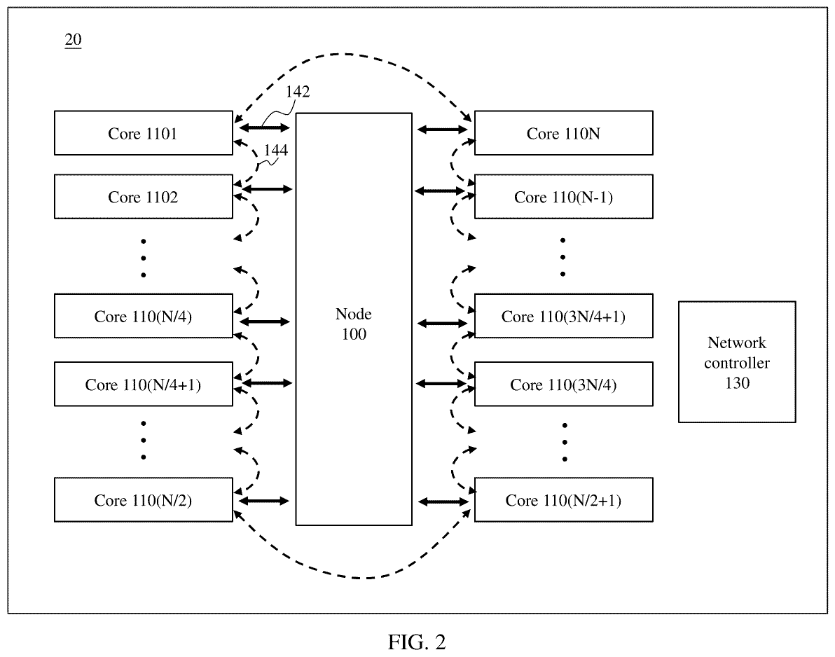

Reference is now made to FIG. 1. FIG. 1 is a flowchart diagram of a method 10, in accordance with some embodiments of the present disclosure. It is understood that additional operations can be provided before, during, and after the processes shown by FIG. 1, and some of the operations described below can be replaced or eliminated, for additional embodiments of the method. The order of the operations/processes may be interchangeable. Throughout the various views and illustrative embodiments, like reference numbers are used to designate like elements. The method 10 includes steps S101 and S102 that are described below with reference to devices 20-40, 60 of FIGS. 2 to 13B.

Reference is now made to FIG. 2. FIG. 2 is a schematic diagram of a device 20, in accordance with various embodiments of the present disclosure. In some embodiments, the device 20 is an NoC system of an integrated circuit to transmit data between nodes and processing units. For example, as illustratively shown in FIG. 2, the device 20 includes cores 1101-110N operating and referred to as processing units, a node 100, a network controller 130, connections 142, and connections 144. In some embodiments, the connections 142 are referred to as bus, and the connections 144 are referred to as of ring structure. The node 100 is implemented as an intermediate node and equipped with the network controller 130 that manages data traffic between multiple processing cores and the network. In some embodiments, the network controller 130 includes a router, which directs data packets based on destination addresses, and a network adapter, which interfaces the processing cores with the network controller 130.

As shown in FIG. 2, the node 100 is coupled to the cores 1101-110N through the connections 142. Every two corresponding ones in the cores 1101-110N is coupled to each other through one of the connections 144. In some embodiments, the connections 142 are a group of metal layers implemented by, for example, one or more lower metal layers (metal-three layer M3 to metal-six layer M6.) The connections 144 are above the connections 142 along a cross-sectional direction of the device and of another group of metal layers implemented by, for example, one or more higher metal layers (metal-seven layer M7 to layers above.) The configurations of FIG. 2 are given for illustrative purposes. Various implements are within the contemplated scope of the present disclosure. For example, in some embodiments, the connections 142 and 144 are of same group of metal layers.

In some embodiments, the node 100 is a main memory device and the cores 1101-110N are memory sub-banks. Specifically, for example, with reference to the method 10 of FIG. 1, in step S101, the network controller 130 selects communication path(s) for data transmission according to the operations of the device 20. For example, during the first operation—the memory multicast operation—for transferring data from the node 100 to multiple cores, data from the node 100 as a single source memory location is multicast to multiple destination cores 1101-110N as memory sub-banks. In some embodiments, the process begins with the network controller 130 initiating the multicast operation by specifying the source memory address and the destination memory sub-banks. The data from the node 100 is then read and simultaneously multicast to all specified cores 1101-110N (e.g., one or all of the cores 1101-110N). Each core independently receives and stores the data.

In the second operation for transferring data from one of the cores, for example, the core 1101 to multiple cores, for example, the core 110(N/2+1) to the core 110(3N/4), the network controller 130 selects the communication path including the connection 142 between the core 1101 and the node 100 and the connection 142 between the node 100 and the core 110(N/2+1) to the core 110(3N/4), as shown in FIG. 2. The network controller 130 initiates the multicast operation, and the data from the node 100 is then read and simultaneously multicast to the core 110(N/2+1) to the core 110(3N/4).

In some embodiments, during the operation for one-to-one inter-unit communication, the network controller 130 further compares a threshold value and a number of hops in the communication path bypassing the node 100 to select the communication path, in which hops are the steps data packets take as they travel between different nodes or cores within the integrated circuits. When the number of hops in the communication path bypassing the node 100 is smaller than or equal to the threshold value, the network controller 130 selects the communication path that bypasses the node 100 and includes the connections 144, which releases the pressure on the node 100 to service data to multiple cores during core-to-core transfers.

Conversely, when the number of hops in the communication path bypassing the node 100 is greater than the threshold value, the network controller 130 selects the communication path involving the node 100 for the better speed and efficiency of data transmission.

Specifically, the threshold value is associated with the number of hops between the start core and the end core through node 100, as well as the number of hops between the start core and the end core when node 100 is bypassed. In some embodiments, the threshold value is double of the number of hops between the start core and the end core through the node 100.

For example, as shown in FIG. 2, when N equals to 16, the number of hops between the start core 1101 and the end core 110(N/2+1) through the node 100 and the connection 142 is 2, the threshold value is correspondingly 4. The number of hops between the start core 1101 and the end core 110(N/2+1) when the node 100 is bypassed is 8, which is greater than the threshold value (4). Accordingly, the network controller 130 selects the communication path involving the node 100 and the 142 to transfer data from the core 1101 and the core 110(N/2+1). Specifically, the core 1101 transfers data to the node 100, and the node 100 further outputs the data to the core 110(N/2+1).

In other embodiments, the number of hops between the start core 1101 and the end core 110(N/4) through the node 100 and the connection 142 is 2, the threshold value is correspondingly 4. The number of hops between the start core 1101 and the end core 110(N/4) when the node 100 is bypassed is 4, which is equal to the threshold value (4). Accordingly, the network controller 130 selects the communication path bypassing the node 100, in which the communication path operatively couples the cores 1101, the cores 110(N/4), and the cores 1102-1103, referred to as intermediate cores between the cores 1101 and 110(N/4) and the connections 144 coupling between the cores 1101 to 110(N/4).

Specifically, with continued reference to the embodiment above, in step S102, transmitting data from the core to the core 110(N/4) is by storing the data in previous cores in the intermediate cores and outputting, by the previous cores, to next ones of the intermediate cores. For example, the core 1101 couples to the communication path and transfers data to and saves the data in the core 1102. The core 1102 further outputs the saved data to the core 1103. Then, the core 1103 outputs the data to the end core 110(N/4).

In some embodiments, the core is configured to transfer data to different cores simultaneously through the communication path including the connections 144 (also referred to as a ring configuration) and another communication path including the connection 142 and the node 100, which mitigates bus stall in transmitting data merely by communication path including the connection 142 and the node 100. Alternative stated, low-overhead ring connection between cores alleviates the congestion issues. Accordingly, with configurations of the present application, by selecting a proper communication path according to the operation and comparison of numbers of hops in different paths, the efficiency of data transfer improves. Moreover, in some embodiments of bypassing the node 100 in data transfer of core-to-core communication, the node 100 is put to deep-sleep/standby mode to save >50% energy consumption in the node 100.

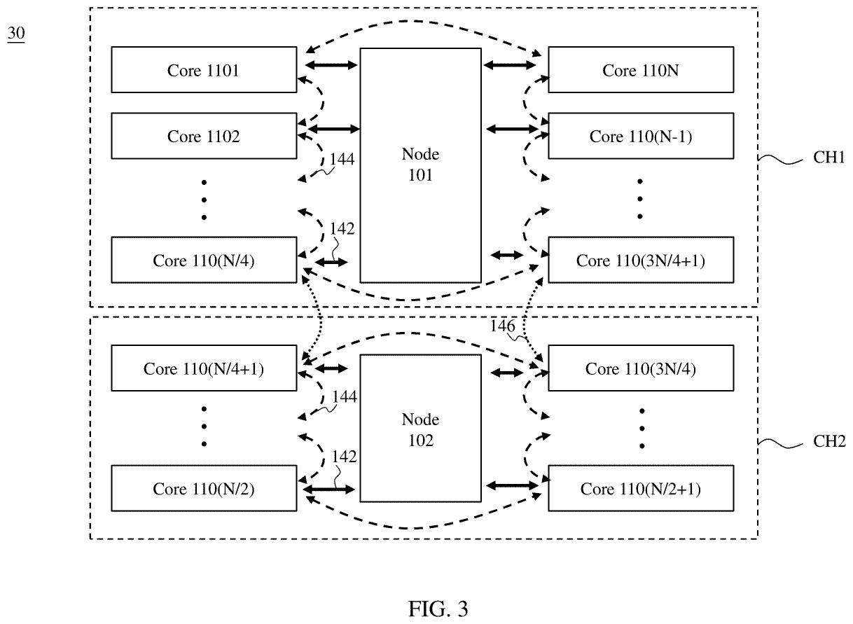

Reference is now made to FIG. 3. FIG. 3 is a schematic diagram of a device 30, in accordance with various embodiments of the present disclosure. In some embodiments, the device 30 is configured with respect to, for example, the device 20. With respect to the embodiments of FIG. 2, like elements in FIG. 3 are designated with the same reference numbers for ease of understanding. The specific operations of similar elements, which are already discussed in detail in above paragraphs, are omitted herein for the sake of brevity. The network controller 130 is not shown in FIG. 3.

Compared with FIG. 2, instead of having a single intermediate node between cores, the device 30 includes a node 101 and a node 102 that are configured with respect to, for example, the node 100, according to some embodiments. The node 101 couples to the cores 1101-110(N/4) and the cores 110(3N/4+1)-110N through the connections 142. Similarly, the node 102 couples to the cores 110 (N/4+1)-110 (N/2) and the cores 110(N/2+1)-110(3N/4) through the connections 142. Every two adjacent cores in the cores 1101-110N couple by the connection 144. In some embodiments of the cores 1101-110N operating memory sub banks and the nodes 101-102 operating as the main memories.

In the embodiments of FIG. 3, it employs multiple-ring configuration and enables the device 300 operates as two independent units for smaller workloads. For example, the node 101, the cores 1101-110(N/4) and the cores 110(3N/4+1)-110N correspond to a first ring structure, and the node 102, the cores 110(N/4+1)-110(N/2), and the cores 110(N/2+1)-110(3N/4) correspond to a second ring structure. In some embodiments, the first ring structure and the second ring structure are configured to perform computation corresponding to channels CH1 and CH2 in a convolution network respectively. Accordingly, multiple channels in the convolution network can be evaluated in parallel. The performance of the convolution network on the device 30 improves.

In some embodiments, the communication configurations of the first ring structure and the second ring structure are different. For example, in some embodiments, for the inter-unit communications, the node 102 is bypassed while the node 101 is involved.

Moreover, communication paths in the device 30 can be programmatically added and disabled. For example, the core 110 (N/4) of the first ring structure is coupled to the core 110 (N/4+1) of the second ring structure through a connection 146, and the core 110 (3N/4+1) of the first ring structure is coupled to the core 110 (3N/4) of the second ring structure through the connection 146, which provides communication paths between the first ring structure and the second ring structure. In some embodiments, the connections 146 are configured with respect to, for example, the connections 144. The configurations of the connections 146 are similar to the connections 144. Hence, the repetitious descriptions are omitted here.

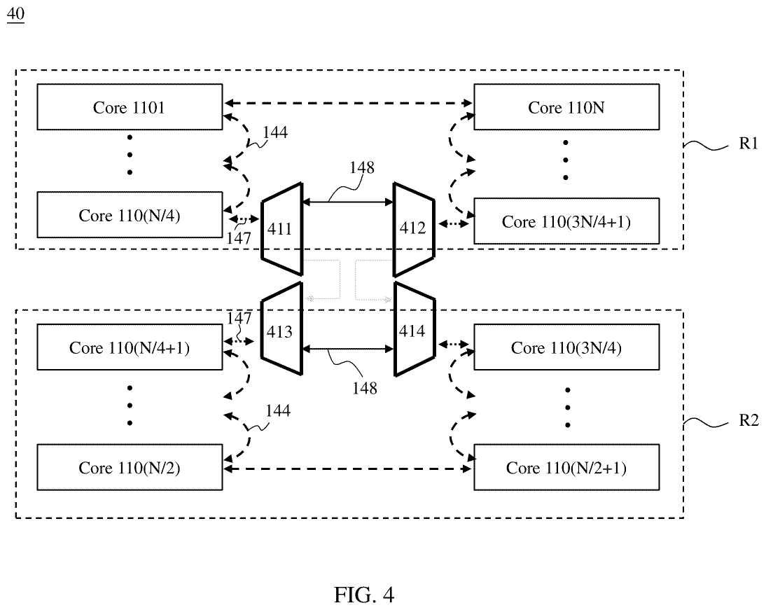

Reference is now made to FIG. 4. FIG. 4 is a schematic diagram of a device 40, in accordance with various embodiments of the present disclosure. In some embodiments, the device 40 is configured with respect to, for example, the device 30. With respect to the embodiments of FIGS. 2-3, like elements in FIG. 4 are designated with the same reference numbers for ease of understanding. The network controller 130 is not shown in FIG. 4.

The device 40 includes multiplexers 411-414 that operate as an intermediate node coupled to the cores 1101-110N. In some embodiments, every two of the multiplexers 411-414 are operatively coupled with each other in response to communication operation controlled by the network controller 130. Specifically, in the ring structure R1, a communication path is selected, by the network controller 130 controlling the multiplexers 411-412, to couple the core 110 (N/4) to the core 110 (3N/4+1) through the multiplexers 411-412, connections 147 between the multiplexers and the cores, and a connection 148 connecting between the multiplexers 411-412. In some embodiments, the core 1101 transfers data to one of the core 110 (3N/4+1) to the core 110N through the connections 144, 147, the multiplexers 411-412, and the connection 148.

Similarly, in the ring structure R2, a communication path is selected, by the network controller 130 controlling the multiplexers 413-414, to couple the core 110 (N/4+1) to the core 110 (3N/4) through the multiplexers 413-414, the connections 147, and the connection 148 connecting between the multiplexers 413-414. In some embodiments, the core 110 (N/2+1) transfers data to one of the core 110 (N/4+1) to the core 110 (N/2) through the connections 144, 147, the multiplexers 413-414, and the connection 148.

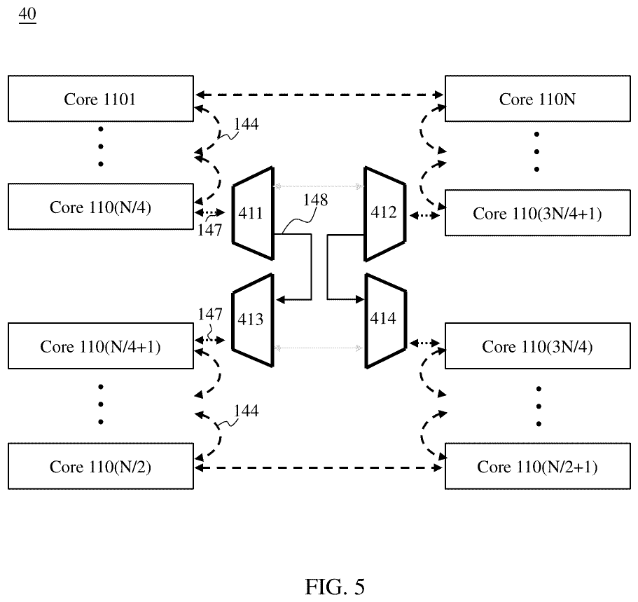

Reference is now made to FIG. 5. FIG. 5 is a schematic diagram of the device 40 corresponding to FIG. 4, in accordance with various embodiments of the present disclosure.

Compared with the embodiments of FIG. 4, one of the core 1101-110 (N/4) and the core 110 (3N/4+1)-110N is configured to transmit inter-unit communication to one of the core 110 (N/4+1)-110 (N/2) and the core 110 (N/2+1)-110 (3N/4) through selecting a communication path coupled with the pair of the multiplexers 411 and 413 or the pair of the multiplexer 412 and 414 by the network controller 130.

For example, the core 110 (N/4) receives the data from the core 1101 through the connections 144 and further transfers the data to the core 110 (N/2) through the communication path coupling the multiplexers 411 and 413, the connections 147, the connection 148 between the multiplexers 411 and 413, and the connections 144 coupled between intermediate cores (e.g., the cores 110 (N/4+2) to the core 110 (N/2-1)) between the core 110 (N/4) and the core 110 (N/2).

The configurations of FIGS. 2-5 are given for illustrative purposes. Various implements are within the contemplated scope of the present disclosure.

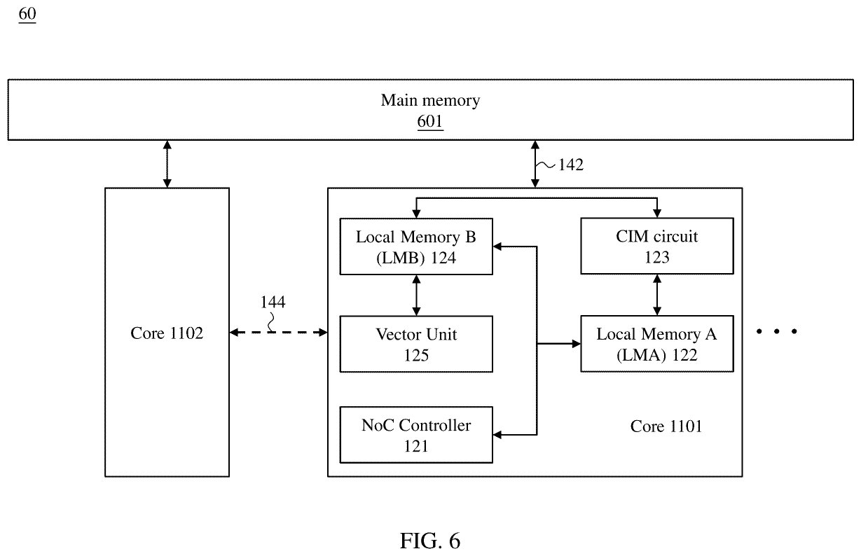

Reference is now made to FIG. 6. FIG. 6 is a schematic diagram part of a device 60 corresponding to the device 20 in FIG. 2, in accordance with various embodiments of the present disclosure. In some embodiments, the device 60 is configured with respect to, for example, the device 20. With respect to the embodiments of FIGS. 2-5, like elements in FIG. 6 are designated with the same reference numbers for ease of understanding. The network controller 130 is not shown in FIG. 6.

In some embodiments, the device 60 includes a main memory 601 configured with respect to, for example, the node 100 of FIG. 2. As shown in FIG. 6, each of the cores 1101-110N includes an NoC controller 121, a local memory A 122, a compute-in-memory (CIM) circuit 123, a local memory B 124, and a vector unit 125. In some embodiments, the device 60 performs machine learning model (e.g., neural network model) computations according to the instructions from the network controller 130. In some embodiments, each of the cores 1101-110N further includes an input and output unit, router, etc., (not shown) for receiving and outputting data from and to other cores or nodes in the NoC system.

In some embodiments, the NoC controller 121 is configured to direct data packets in the core and between other cores and the main memory 601 by controlling the local memory A 122, the CIM circuit 123, the local memory B 124, and vector unit 125. In some embodiments, the NoC controller 121 includes a buffer storing the instructions for the core 1101.

The local memory A 122 and the local memory B 124 may be storage devices like flip-flops, random access memory, static random-access memory (SRAM), resistive random-access memory (ReRAM), etc.

In some embodiments, the CIM circuit 123 is configured to perform multiply-accumulate (MAC) operation on input activation of a machine learning model from the local memory A 122 and weight data of the machine learning model stored in the CIM circuit to generate outputs to the local memory B 124. In some embodiments, the CIM circuit 123 includes bit cells, sense amplifiers, latches, input registers, local computing cells, adder tree, an accumulator, and/or other suitable devices for MAC operation.

In some embodiments, for practical applications, the machine learning model of may be utilized in various fields such as machine vision, image classification, or data classification. For example, the machine learning model may be used for classifying medical images. For example, it can be used to classify X-ray images in normal conditions, with pneumonia, with bronchitis, or with heart disease. The machine learning model may also be used to classify ultrasound images with normal fetuses or abnormal fetal positions. On the other hand, the machine learning model can also be used to classify images collected in automatic driving, such as distinguishing normal roads, roads with obstacles, and road conditions images of other vehicles. Furthermore, the machine learning model can be utilized in other similar fields, such like music spectrum recognition, spectral recognition, big data analysis, data feature recognition and other related machine learning fields.

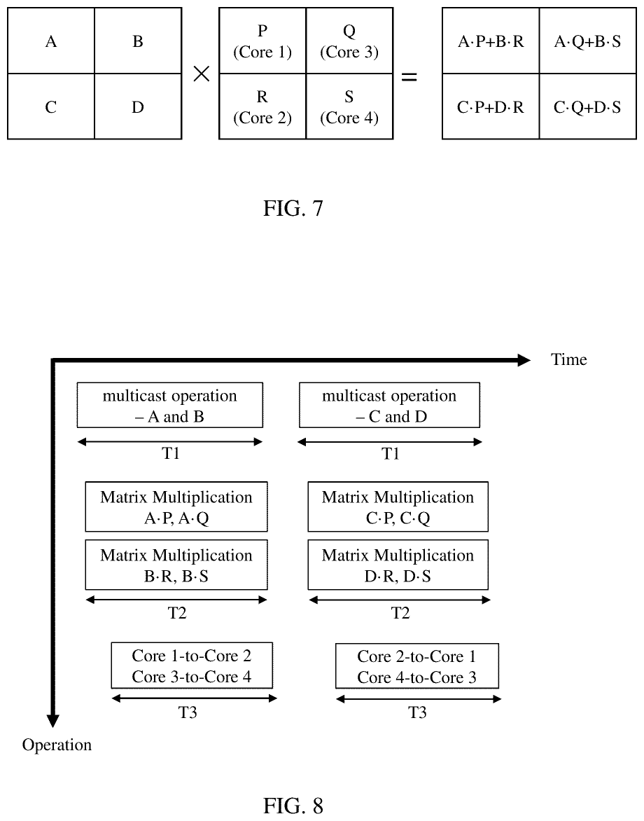

Reference is now made to FIGS. 7-13B to describe embodiments of matrix multiplications employing the devices, for example, 20 of FIG. 2 and 60 of FIG. 6. In some embodiments, large matrix multiplications (MM) get partitioned into multiple small matrices that are computed on separate cores.

FIG. 7 shows an input matrix with elements A to D multiplying a weight matrix with elements P, R, Q, and S, which are stored in cores 1 to 4, along with the corresponding results of the multiplication of these two matrices. In some embodiments, the operations for generating the results, multicast operations, matrix multiplication operations, and core-to-core transfers as discussed with reference to FIGS. 2-6 are required as shown in FIG. 8.

In some embodiments, the cores 1 to 4 are configured with respect to, for example, the core shown in FIG. 6.

During operation, with reference to FIGS. 7 to 10B together, firstly, for the multicast operation of elements A and B in a time period T1, element A of the matrix is loaded from a main memory 601 to both the core 1 (which stores element P) and the core 3 (which stores element Q), and element B of the matrix is loaded from the main memory 601 to both the core 2 (which stores element R) and the core 4 (which stores element S.)

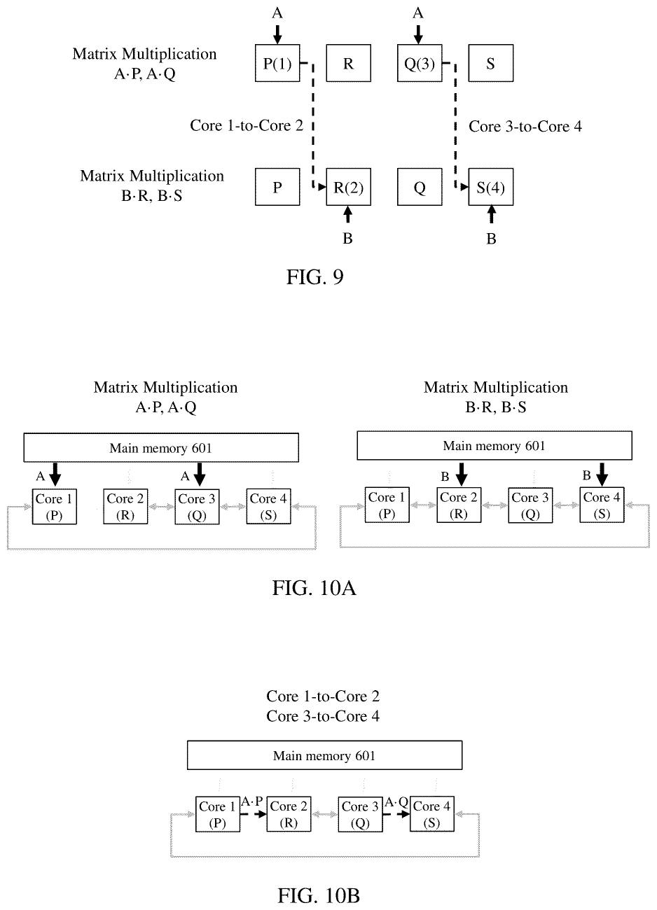

Then, as shown in FIGS. 9 and 10A, for the matrix multiplication operation in a time period T2, the core 1 multiplies element A with element P, and the core 3 multiplies element A with element Q, generating the corresponding results A·P and A·Q. Similarly, the core 2 multiplies element B with element R, and the core 4 multiplies element B with element S, generating the corresponding results B·R and B·S.

Thirdly, in a time period T3, the core 1 transmits inter-unit communication to the core 2 for accumulating the result A·P with the result B·R in the core 2. Similarly, the core 3 transmits inter-unit communication to the core 4 for accumulating the result A·Q with the result B·S in the core 4, as shown in FIGS. 9 and 10B.

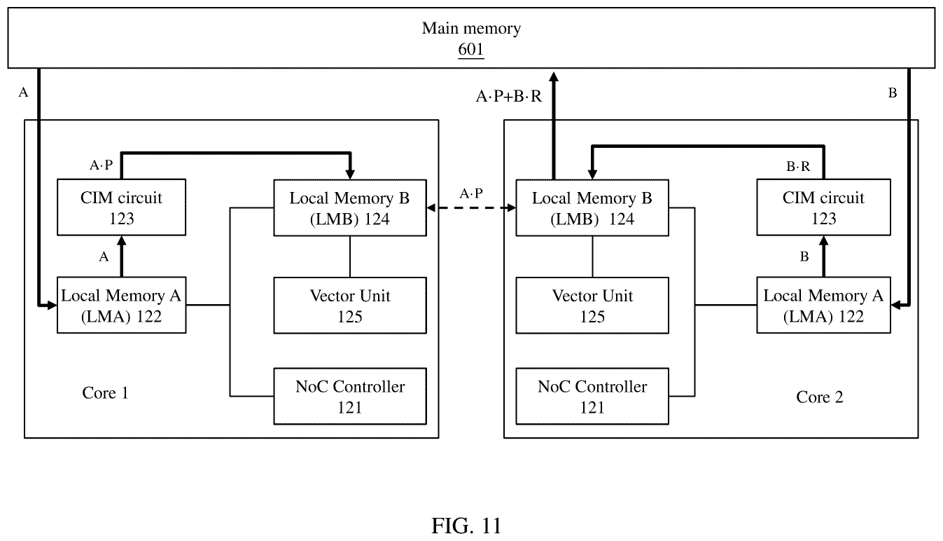

Specifically, taking the cores 1 and 2 as example, as shown in FIG. 11 depicting data flows of the core 1 and 2, firstly, element A is transferred from the main memory 601 and stored in the local memory A 122 of the core 1, while the CIM circuit 123 of the core 1 stores the element P. Then, the CIM circuit 123 performs multiplication of element A and element P to generate the result A·P to the local memory B 124 of the core 1. Similarly, element B is transferred from the main memory 601 and stored in the local memory A 122 of the core 2, while the CIM circuit 123 of the core 2 stores the element R. Then, the CIM circuit 123 performs multiplication of element B and element R to generate the result B·R to the local memory B 124.

The core 1 further transfers result A. P to the local memory B 124 of the core 2 for accumulation of A·P+B·R, and the core 2 further transfers the accumulation of A·P+B·R to the main memory 601.

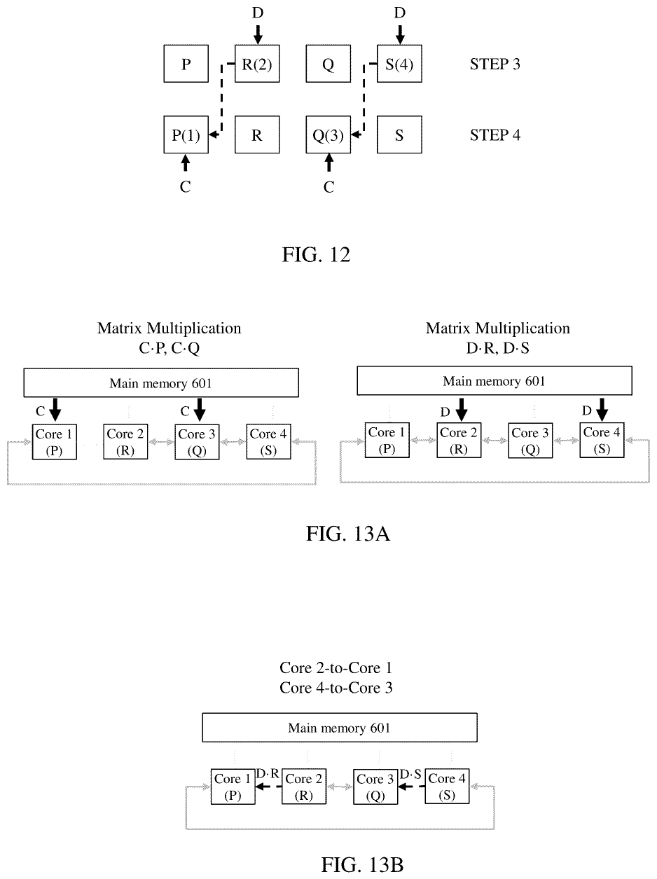

With reference back to FIGS. 7 and 8 and further FIGS. 12 to 13A together, firstly, for the multicast operation of elements C and D in the time period T1, element C of the matrix is loaded from the main memory 601 to both the core 1 (which stores element P in the CIM circuit 123 thereof) and the core 3 (which stores element Q in the CIM circuit 123 thereof), and element D of the matrix is loaded from the main memory 601 to both the core 2 (which stores element R in the CIM circuit 123 thereof) and the core 4 (which stores element S in the CIM circuit 123 thereof.)

Then, as shown in FIGS. 12 and 13B, for the matrix multiplication operation in the time period T2, the core 1 multiplies element C with element P, and the core 3 multiplies element C with element Q, generating the corresponding results C·P and C·Q. Similarly, the core 2 multiplies element D with element R, and the core 4 multiplies element D with element S, generating the corresponding results D·R and D·S.

Thirdly, in the time period T3, the core 2 transmits inter-unit communication to the core 1 for accumulating the result D·R with the result C·P in the core 1. Similarly, the core 4 transmits inter-unit communication to the core 3 for accumulating the result D·S with the result C·Q in the core 3, as shown in FIGS. 12 and 13B.

The core 1 further transfers the accumulation of C·P+D·R to the main memory 601. The core 3 further transfers the accumulation of C·Q+D·S to the main memory 601. Through the processes descripted above, a result corresponding to the matrix multiplication of the matrix with elements A-D and the matrix with elements P-S is generated in the main memory 601.

Some approaches, unlike the ring structure designs shown in FIGS. 10B and 13B, rely solely on main memory for all data transfers. In these scenarios, core-to-core communication must wait until the multicast operation completes. This is because the main memory is engaged in read mode during the multicast, preventing simultaneous write operations. Consequently, the results of matrix multiplications cannot be written back to main memory during the multicast. Since the same connections are used for both multicast and core-to-core communication, the transfer times are equal (T1=T3). This leads to a total latency of approximately 2(T1+T3)=4T1, potentially causing stalls and latency degradation.

Conversely, the present application, as illustrated in FIG. 10B, utilizes ring connectivity between cores to provide an alternate data path. This allows for the accumulation of A·P and B·R, A·Q and B·S, C·P and D·R, and C·Q and D·S via core-to-core transfer through the ring structures. As depicted in FIG. 8, this enables temporal overlap of transfers, leading to a latency improvement of approximately 2×. Assuming equal bandwidth for both transfer modes (T1=T3), the total latency is reduced to roughly 2T1.

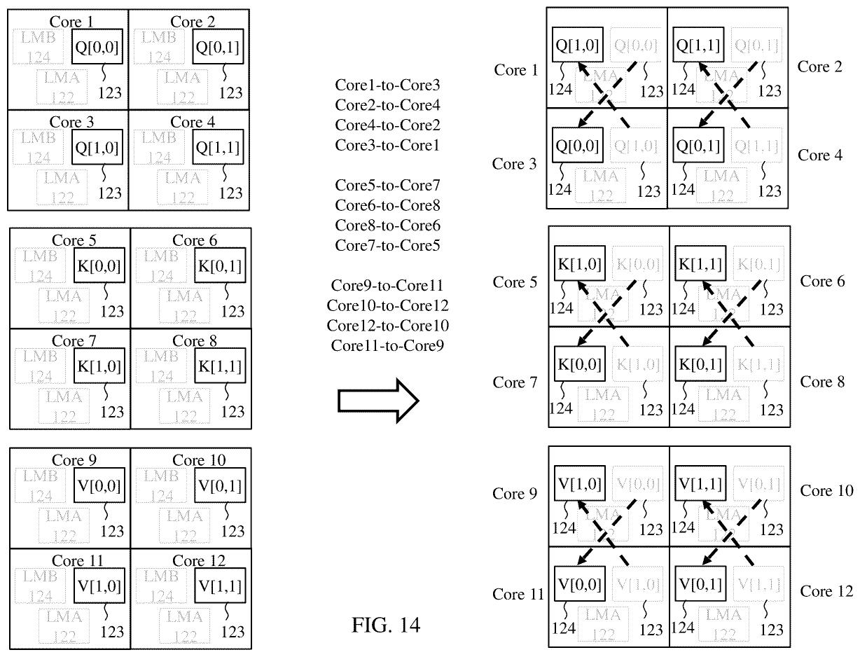

Reference is now made to FIGS. 14 to 16D for embodiments of multiplications of matrices Q, K^{T}, and V that utilize the method 10, the devices 20-40, 60 of FIGS. 2 to 13B, whose transfers are dominated by core-to-core transfers.

FIG. 14 is a schematic diagram of data transfer corresponding to multiplications of matrices Q, K^{T}, and V in accordance with various embodiments of the present disclosure.

Initially, the main memory 601 performs the multicast operations to transfer elements of the matrices Q, K^{T}, and V to the cores Core 1 to Core 12 and saved in the CIM circuits 123 thereof respectively. Specifically, the Core 1 to Core 4 store the data in the matrix Q. The Core 5 to Core 8 store the data in the matrix K. The Core 9 to Core 12 store the data in the matrix V.

The core-to-core transfers proceed as shown in FIG. 14. For example, the element Q[0,0] is transfer from the CIM circuit 123 in the core Core 1 to the local memory B 124 in the core Core 3, as the element Q[1,0] is transfer from the CIM circuit 123 in the core Core 3 to the local memory B 124 in the core Core 1. The element Q[0,1] is transfer from the CIM circuit 123 in the core Core 2 to the local memory B 124 in the core Core 4, as the element Q[1,1] is transfer from the CIM circuit 123 in the core Core 4 to the local memory B 124 in the core Core 2.

Similarly, the element K[0,0] is transfer from the CIM circuit 123 in the core Core 5 to the local memory B 124 in the core Core 7, as the element K[1,0] is transfer from the CIM circuit 123 in the core Core 7 to the local memory B 124 in the core Core 5. The element K[0,1] is transfer from the CIM circuit 123 in the core Core 6 to the local memory B 124 in the core Core 8, as the element K[1,1] is transfer from the CIM circuit 123 in the core Core 8 to the local memory B 124 in the core Core 6.

V[0,0] is transfer from the CIM circuit 123 in the core Core 9 to the local memory B 124 in the core Core 11, as the element V[1,0] is transfer from the CIM circuit 123 in the core Core 11 to the local memory B 124 in the core Core 9. The element V[0,1] is transfer from the CIM circuit 123 in the core Core 10 to the local memory B 124 in the core Core 12, as the element V[1,1] is transfer from the CIM circuit 123 in the core Core 12 to the local memory B 124 in the core Core 10.

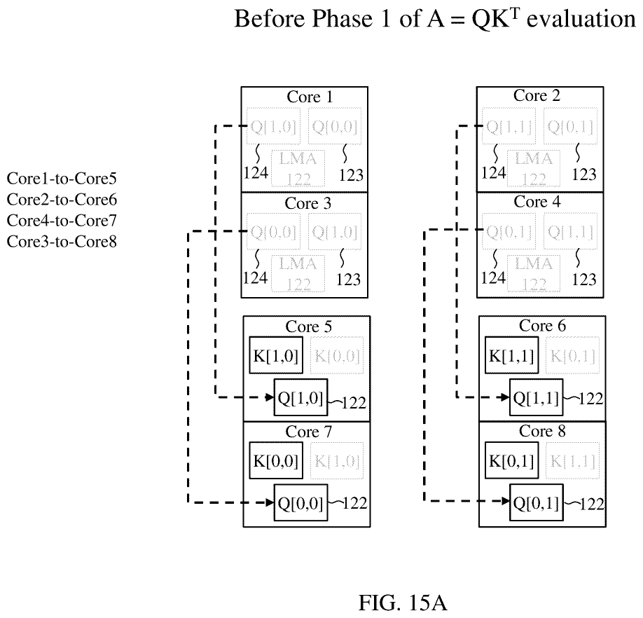

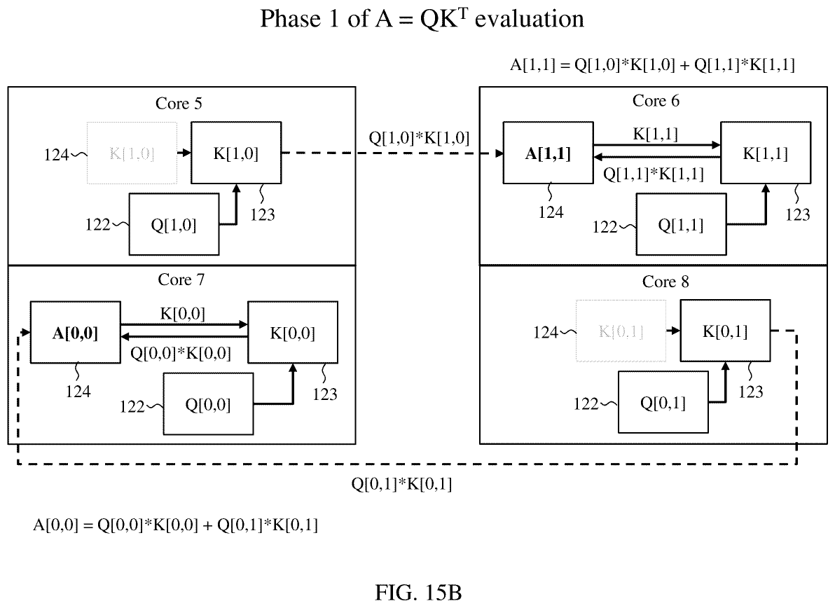

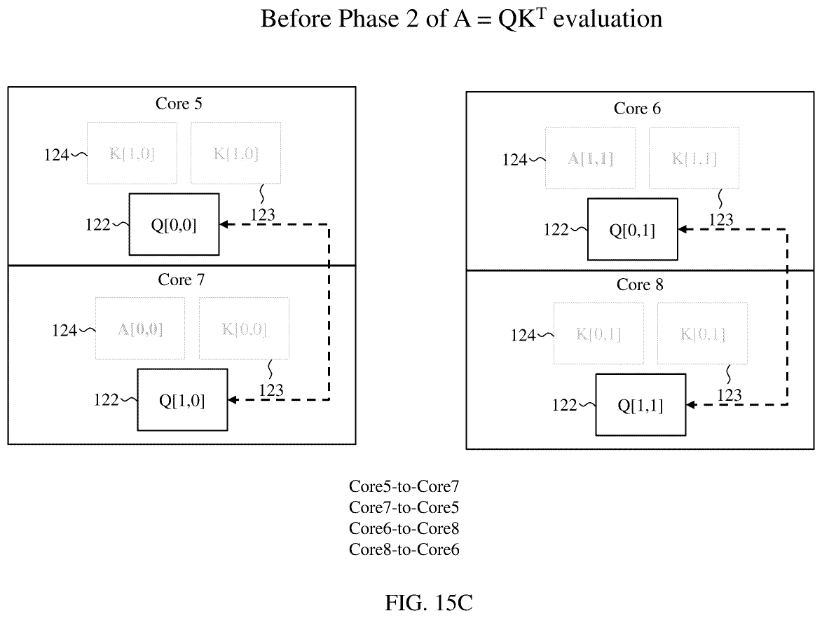

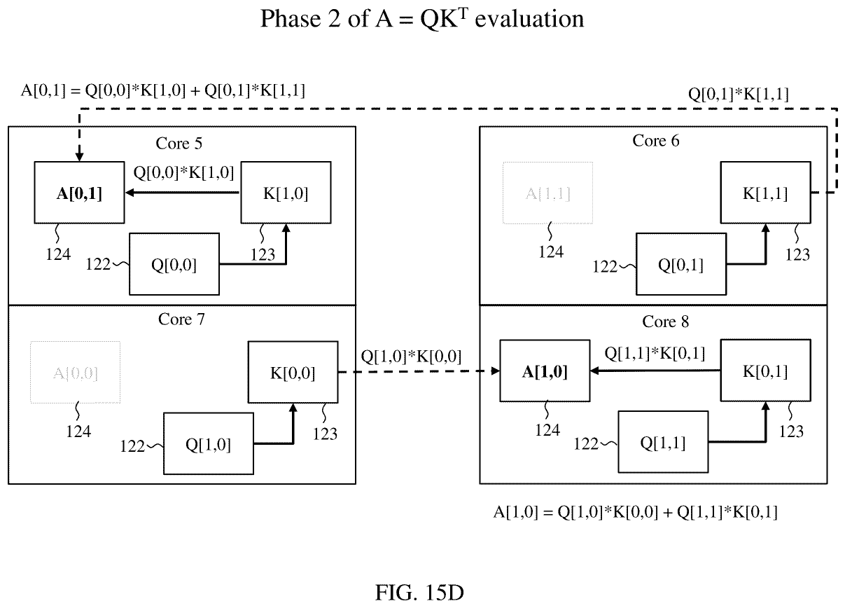

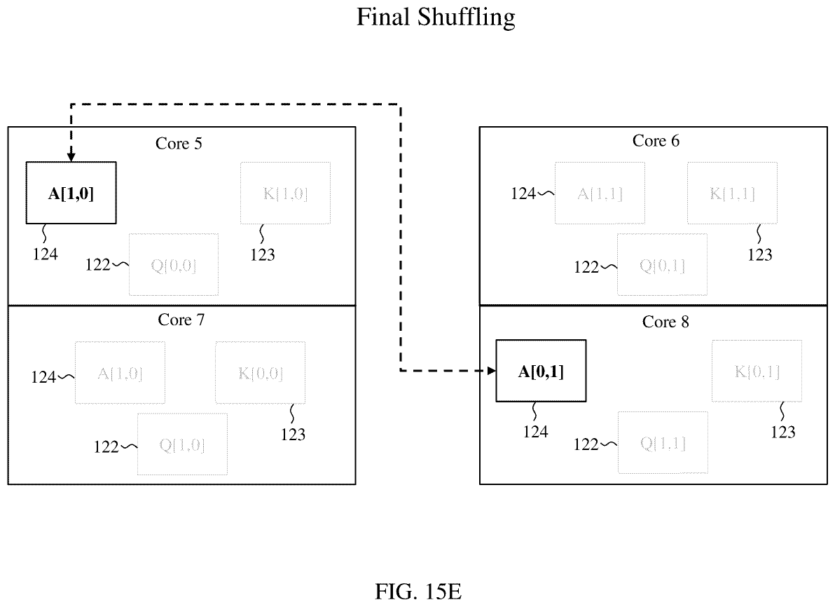

FIG. 15A is a schematic diagram of data flow before phase 1 of multiplications of matrices Q and K^{T}, in accordance with various embodiments of the present disclosure.

The element Q[1,0] is transfer from the local memory B 124 in the core Core 1 to the local memory A 122 in the core Core 5. The element Q[0,0] is transfer from the local memory B 124 in the core Core 3 to the local memory A 122 in the core Core 7. The element Q[1,1] is transfer from the local memory B 124 in the core Core 2 to the local memory A 122 in the core Core 6. The element Q[0,1] is transfer from the local memory B 124 in the core Core 4 to the local memory A 122 in the core Core 8.

FIG. 15B is a schematic diagram of data flow in phase 1 of multiplications of matrices Q and K^{T}, in accordance with various embodiments of the present disclosure.

As shown in FIG. 15B, elements K[1,0], K[1,1], K[0,0], and K[0,1] in the local memories B 124 of the cores Core 5 to Core 7 are transferred and stored in the CIM circuits 123 in the cores Core 5 to Core 7.

Then, in operation, the CIM circuits 123 in the cores Core 5 to Core 8 perform multiplication of elements from the local memories A 122 thereof with elements in the CIM circuits 123. For example, the CIM circuit 123 in the core Core 5 multiplies element Q[1,0] with element K[1,0] to generate Q[1,0]*K[1,0]. The configurations of multiplications in other cores are similar to that in the core Core 5. Hence, the repetitious descriptions are omitted here.

The core 5 further transfers Q[1,0]*K[1,0] to the local memory B 124 of the core 6 for accumulation of Q[1,0]*K[1,0] and Q[1,1] *K[1,1] to generate element A[1,1]. Similarly, the core 8 further transfers Q[0,1]*K[0,1] to the local memory B 124 of the core 7 for accumulation of Q[0,1]*K[0,1] and Q[0,0]*K[0,0] to generate element A[0,0], as shown in FIG. 15B.

FIG. 15C is a schematic diagram of data flow before phase 2 of multiplications of matrices Q and K^{T}, in accordance with various embodiments of the present disclosure.

The element Q[0,0] is transfer from local memory A 122 in the core Core 5 to the local memory A 122 in the core Core 7, as the element Q[1,0] is transfer from local memory A 122 in the core Core 7 to the local memory A 122 in the core Core 5. The element Q[0,1] is transfer from local memory A 122 in the core Core 6 to the local memory A 122 in the core Core 8, as the element Q[1,1] is transfer from local memory A 122 in the core Core 8 to the local memory A 122 in the core Core 6.

FIG. 15D is a schematic diagram of data flow in phase 2 of multiplications of matrices Q and K^{T}, in accordance with various embodiments of the present disclosure.

In operation of phase 2, the CIM circuits 123 in the cores Core 5 to Core 8 perform multiplication of elements from the local memories A 122 thereof with elements in the CIM circuits 123. For example, the CIM circuit 123 in the core Core 5 multiplies element Q[0,0] with element K[1,0] to generate Q[0,0]*K[1,0]. The configurations of multiplications in other cores are similar to that in the core Core 5. Hence, the repetitious descriptions are omitted here.

The core 6 further transfers Q[0,1]*K[1,1] to the local memory B 124 of the core 5 for accumulation of Q[0,1]*K[1,1] and Q[0,0]*K [1,0] to generate element A[0,1]. Similarly, the core 7 further transfers Q[1,0]*K[0,0] to the local memory B 124 of the core 8 for accumulation of Q[1,0]*K[0,0] and Q[1,1]*K[0,1] to generate element A[1,0], as shown in FIG. 15D. Accordingly, matrix A as a result of multiplication of the matrices Q and K^{T} is produced.

For further calculation, a shuffling of data is performed. FIG. 15E is a schematic diagram of data flow in final stage of multiplications of matrices Q and K^{T}, in accordance with various embodiments of the present disclosure.

In FIG. 15E, the element A[0,1] is transfer from the local memory B 124 in the core Core 5 to the local memory B 124 in the core Core 8, as the element A[1,0] is transfer from the local memory B 124 in the core Core 8 to the local memory B 124 in the core Core 5.

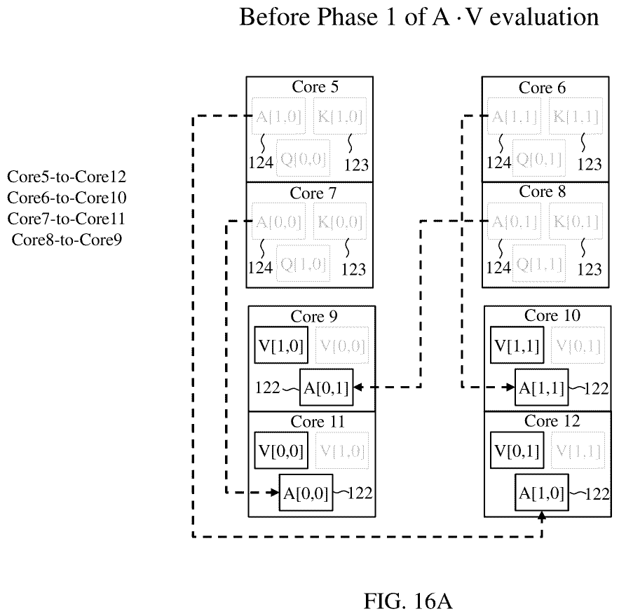

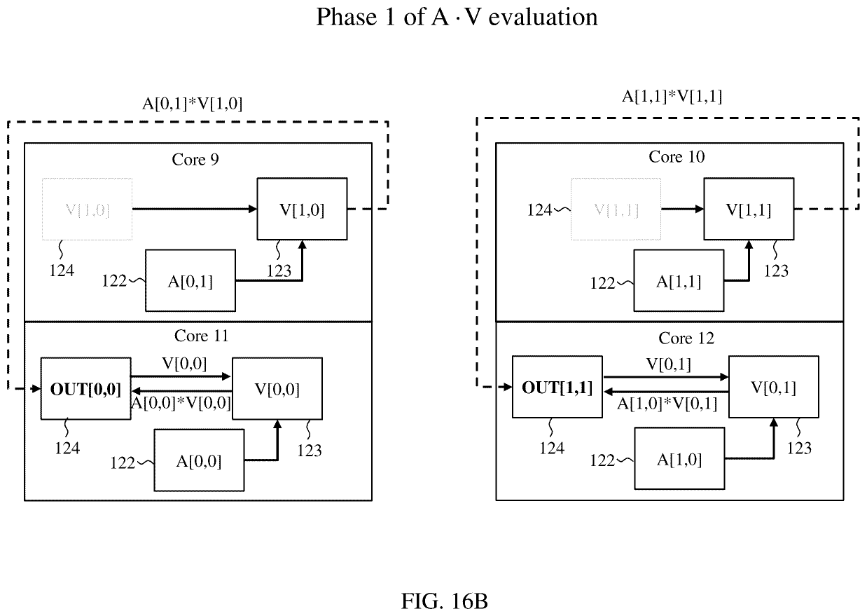

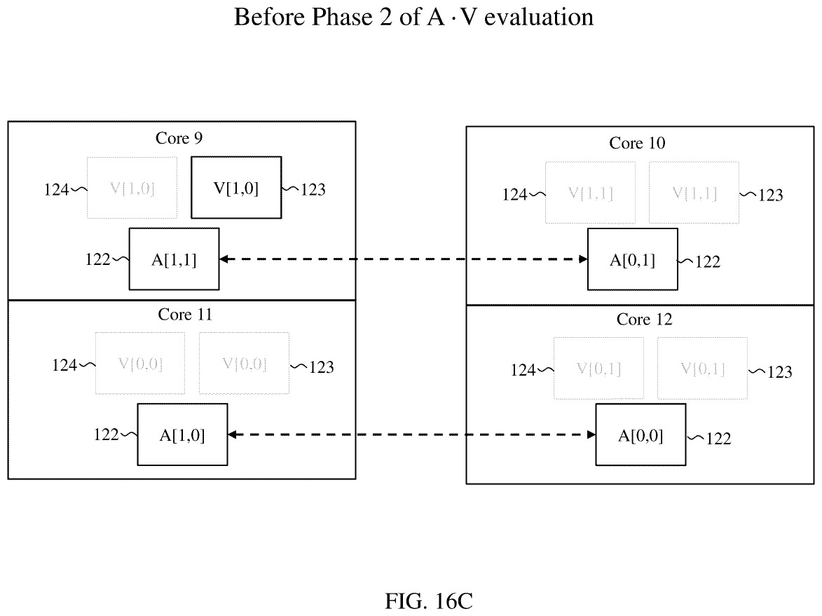

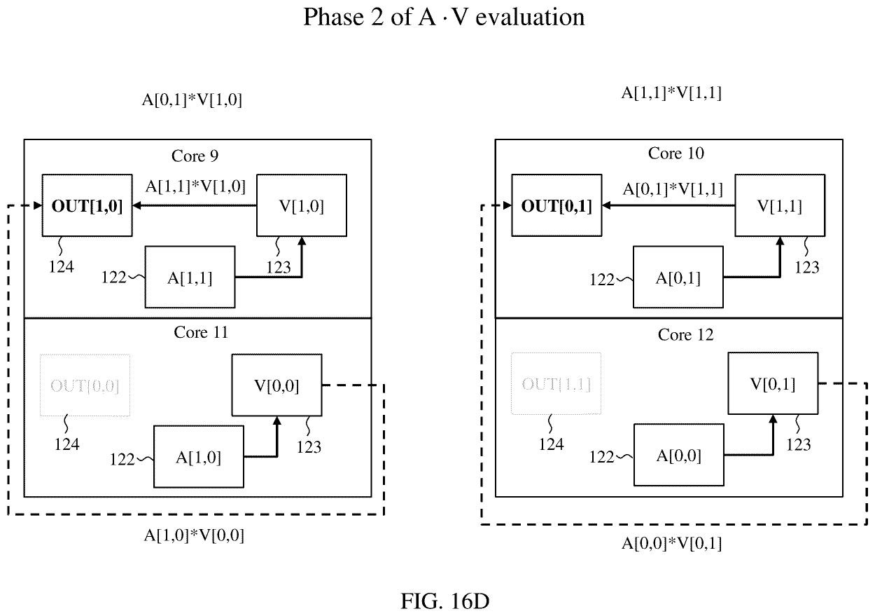

FIG. 16A is a schematic diagram of data flow before phase 1 of multiplications of matrices A and V, in accordance with various embodiments of the present disclosure.

The element A[1,0] is transfer from the local memory B 124 in the core Core 5 to the local memory A 122 in the core Core 12. The element A[1,1] is transfer from the local memory B 124 in the core Core 6 to the local memory A 122 in the core Core 10. The element A[0,0] is transfer from the local memory B 124 in the core Core 7 to the local memory A 122 in the core Core 11. The element A[0,1] is transfer from the local memory B 124 in the core Core 8 to the local memory A 122 in the core Core 11.

FIG. 16B is a schematic diagram of data flow in phase 1 of multiplications of matrices A and V, in accordance with various embodiments of the present disclosure.

As shown in FIG. 16B, elements V[1,0], V[1,1], V[0,0], and V[0,1] in the local memories B 124 of the cores Core 9 to Core 12 are transferred and stored in the CIM circuits 123 in the cores Core 9 to Core 12.

Then, in operation, the CIM circuits 123 in the cores Core 9 to Core 12 perform multiplication of elements from the local memories A 122 thereof with elements in the CIM circuits 123. For example, the CIM circuit 123 in the core Core 9 multiplies element A[0,1] with element V[1,0] to generate A[0,1]*V[1,0]. The configurations of multiplications in other cores are similar to that in the core Core 9. Hence, the repetitious descriptions are omitted here.

The core 9 further transfers A[0,1]*V[1,0] to the local memory B 124 of the core 11 for accumulation of A[0,1]*V[1,0] and A[0,0]*V[0,0] to generate element OUT[0,0]. Similarly, the core 10 further transfers A[1,1]*V[1,1] to the local memory B 124 of the core 124 for accumulation of A[1,1]*V[1,1] and A[1,0]*V[0,1] to generate element OUT[1,1], as shown in FIG. 16B.

FIG. 16C is a schematic diagram of data flow before phase 2 of multiplications of matrices A and V, in accordance with various embodiments of the present disclosure.

The element A[0,1] is transfer from local memory A 122 in the core Core 9 to the local memory A 122 in the core Core 10, as the element A[1,1] is transfer from local memory A 122 in the core Core 10 to the local memory A 122 in the core Core 9. The element A[0,0] is transfer from local memory A 122 in the core Core 11 to the local memory A 122 in the core Core 12, as the element A[1,0] is transfer from local memory A 122 in the core Core 12 to the local memory A 122 in the core Core 11.

FIG. 16D is a schematic diagram of data flow in phase 2 of multiplications of matrices A and V, in accordance with various embodiments of the present disclosure.

In operation of phase 2, the CIM circuits 123 in the cores Core 9 to Core 12 perform multiplication of elements from the local memories A 122 thereof with elements in the CIM circuits 123. For example, the CIM circuit 123 in the core Core 9 multiplies element A[1,1] with element V[1,0] to generate A[1,1]*V[1,0]. The configurations of multiplications in other cores are similar to that in the core Core 9. Hence, the repetitious descriptions are omitted here.

The core 11 further transfers A[1,0]*V[0,0] to the local memory B 124 of the core 9 for accumulation of A[1,0]*V[0,0] and A[1,1]*V[1,0] to generate element OUT[1,0]. Similarly, the core 12 further transfers A[0,0]*V[0,1] to the local memory B 124 of the core 10 for accumulation of A[0,0]*V[0,1] and A[0,1]*V[1,1] to generate element OUT[1,0], as shown in FIG. 16D. Accordingly, matrix OUT as a result of multiplication of the matrices Q, K^{T}, and V is produced.

Some embodiments of the present application provide an NoC system, in which for transformer models, large matrix multiplications are partitioned into smaller matrices, necessitating multiple core-to-core data transfers. Relying solely on main memory can cause performance stalls due to congestion. A low-overhead ring connection between cores alleviates these issues. Adding an adaptive transfer scheme and MUX-based routing enhances utilization, and main memory can enter standby mode once multicasting transfers are complete.

In some embodiments, a device is provided and includes multiple first processing units; multiple first connections each coupled between corresponding two units in the processing units; and a first intermediate node coupled to the first processing units through multiple second connections different from the first connections. Each of the first processing units is configured to transmit inter-unit communication to a corresponding unit in the first processing units through at least one of the first connections when the first intermediate node is bypassed.

In some embodiments, a method is provided and includes following steps: selecting a first communication path between a first processing unit and a second processing unit, wherein multiple first connections and multiple first intermediate processing units are operatively coupled to the first communication path; and transmitting first data through the first communication path by firstly storing the first data in previous units of the first intermediate processing units and outputting, by the previous units, the first data to next ones of the first intermediate processing units.

In some embodiments, a device is provided and includes multiple processing units; and an intermediate node configured to transfer first data to a first group of the processing units through a first portion in multiple first connections and transfer second data to second group of the processing units through a second portion in the first connections. The first group of units in the processing units are configured to generate, according to the first data and third data stored in the first group of units, corresponding first result data to the second group of units in the units through multiple second connects different from the first connects.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A device, comprising:
A plurality of first processing units;
a plurality of first connections each coupled between corresponding two units in the plurality of first processing units; and
a first intermediate node coupled to the plurality of first processing units through a plurality of second connections different from the plurality of first connections,
wherein each of the plurality of first processing units is configured to transmit inter-unit communication to a corresponding unit in the plurality of first processing units through at least one of the plurality of first connections when the first intermediate node is bypassed.

2. The device of claim 1, further comprising:
a plurality of second processing units coupled with each other through a plurality of third connections;
a second intermediate node coupled to the plurality of second processing units through a plurality of fourth connections;
a fifth connection coupling a first unit in the plurality of first processing units and an adjacent first unit in the plurality of second processing units; and
a sixth connection coupling a second unit in the plurality of first processing units and an adjacent second unit in the plurality of second processing units.

3. The device of claim 2, wherein each of the plurality of second processing units is configured to transmit inter-unit communication to a corresponding unit in the plurality of second processing units through at least one of the plurality of first connections when the second intermediate node is bypassed and the first intermediate node operates in the inter-unit communication between the plurality of first processing units.

4. The device of claim 1, wherein the first intermediate node comprises a plurality of multiplexers,
wherein each of the plurality of multiplexers is coupled to one of the first processing units, and two adjacent multiplexers in the plurality of multiplexers operatively coupled with each other.

5. The device of claim 1, wherein the plurality of first processing units are configured to perform multiply-accumulate (MAC) operation to output results to corresponding ones in the plurality of first processing units through the plurality of first connections.

6. The device of claim 1, wherein the first intermediate node is a main memory device and the plurality of first processing units are a plurality of memory sub-banks.

7. The device of claim 1, wherein the plurality of first connections are a first group of metal layers, and the plurality of second connections are a second group of metal layers below the first group of metal layers.

8. A method, comprising:
selecting a first communication path between a first processing unit and a second processing unit, wherein a plurality of first connections and a plurality of first intermediate processing units are operatively coupled to the first communication path; and
transmitting first data through the first communication path by firstly storing the first data in previous units of the plurality of first intermediate processing units and outputting, by the previous units, the first data to next ones of the plurality of first intermediate processing units.

9. The method of claim 8, further comprising:
selecting a second communication path between the first processing unit and the second processing unit, wherein a plurality of second connections and an intermediate node are operatively coupled to the second communication path; and
transmitting the first data through the second communication path by firstly storing the first data in the intermediate node and outputting, by the intermediate node, to the second processing unit.

10. The method of claim 9, further comprising:
comparing a threshold value and a number of hops in the first communication path to select one of the first communication path and the second communication path.

11. The method of claim 10, wherein the threshold value is associated with the number of hops in the first communication path and a number of hops in the second communication path.

12. The method of claim 10, wherein the threshold value is double of a number of hops in the second communication path.

13. The method of claim 12, wherein selecting the first communication path comprises:
coupling the first processing unit to one in the plurality of first connections and coupling the second processing unit to another one in the plurality of first connections when the number of hops in the first communication path is smaller than the threshold value.

14. The method of claim 12, wherein selecting the second communication path comprises:
coupling the first processing unit to one in the plurality of second connections and coupling the second processing unit to another one in the plurality of second connections when the number of hops in the first communication path is greater than the threshold value.

15. The method of claim 8, further comprising:
selecting a second communication path between the second processing unit and a third processing unit and transmitting the first data through the second communication path, wherein the second communication path couples a plurality of first multiplexers, a plurality of second connections between the plurality of first multiplexers, the second processing unit, and the third processing unit, and a third connection between the plurality of first multiplexers.

16. The method of claim 15, further comprising:
selecting a third communication path between a fourth processing unit and a fifth processing unit and transmitting second data through the third communication path, wherein the third communication path couples a plurality of second multiplexers, a plurality of fourth connections between the plurality of second multiplexers, the fourth processing unit, and the fifth processing unit, and a fifth connection between the plurality of second multiplexers.

17. The method of claim 8, further comprising:
selecting a second communication path between the second processing unit and a third processing unit and transmitting the first data through the second communication path, wherein the second communication path couples a plurality of first multiplexers, a plurality of second connections between the plurality of first multiplexers, the second processing unit, and the third processing unit, a third connection between the plurality of first multiplexers, and a plurality of fourth connections coupled between a plurality of second intermediate processing unit between the second processing unit and the third processing unit.

18. A device, comprising:
a plurality of processing units; and
an intermediate node configured to transfer first data to a first group of the plurality of processing units through a first portion in a plurality of first connections and transfer second data to second group of the plurality of processing units through a second portion in the plurality of first connections,
wherein the first group of units in the plurality of processing units are configured to generate, according to the first data and third data stored in the first group of units, corresponding first result data to the second group of units in the plurality of processing units through a plurality of second connects different from the plurality of first connects.

19. The device of claim 18, wherein the first data and the second data correspond to input activations of a machine learning model, and the third data correspond to weight data of the machine learning model.

20. The device of claim 18, wherein the second group of unit are configured to generate, according to the second data and fourth data stored in the second group of units, corresponding second result data,
wherein the second group of units are further configured to perform accumulation of the corresponding first result data and the corresponding second result data to generate third result data to the intermediate node.
